(19) United States
(12) Patent Application Publication
(10) Pub. No.: US 2022/0206355 A1
(43) Pub. Date: Jun. 30, 2022

(54) LIDAR SYSTEMS WITH IMPROVED TUNABLE OPTICAL DELAY LINES

(71) Applicant: SEMICONDUCTOR COMPONENTS INDUSTRIES, LLC, Phoenix, AZ (US)

(72) Inventor: Haiming WANG, Fremont, CA (US)

(73) Assignee: SEMICONDUCTOR COMPONENTS INDUSTRIES, LLC, Phoenix, AZ (US)

(21) Appl. No.: 17/136,383

(22) Filed: Dec. 29, 2020

(51) Int. Cl. G02F 1/19; G02F 1/01; G01S 7/481; G01S 17/10

(52) U.S. Cl. CPC G02F 1/19; G02F 1/011; G02F 2201/20; G01S 7/481; G01S 17/10; G02F 1/0121

(57) ABSTRACT

A light detection and ranging (LIDAR) system may include a laser and a plurality of single photon avalanche diodes (SPADs) that are triggered by laser light that reflects off a target scene. The LIDAR system may have an optical delay line from which laser light is emitted. It may be desirable to have a tunable optical delay line that has an adjustable delay time. In particular, the tunable optical delay line may include a core layer through which the laser light propagates between cladding layers. One or more of the cladding layers may be formed from electro-optical material that has an adjustable index of refraction when voltage is applied. Due to the adjusted index of refraction, a path length of the light within the delay line may be changed, thereby changing the delay time.

### BACKGROUND

This relates generally to imaging systems, and more specifically, to LIDAR (light detection and ranging) based imaging systems.

Conventional LIDAR imaging systems illuminate a target with light (typically a coherent laser pulse) and measure the return time of reflections off the target to determine a distance to the target and light intensity to generate three-dimensional images of a scene. These LIDAR imaging systems may be optical phased array (OPA) LIDAR systems, in which an optical delay line is used for laser beam steering and scanning. Although optical delay lines may be adjustable mechanically, thermal-optically, or electro-optically, present systems are too slow, require too much power, and require a high cost of packaging.

It would therefore be desirable to be able to provide improved optical delay lines for LIDAR systems.

### BRIEF DESCRIPTION OF THE DRAWINGS

FIG. 1 is a schematic diagram of an illustrative system that includes a LIDAR system.

FIG. 2 is a circuit diagram showing an illustrative single-photon avalanche diode pixel that may be used in a LIDAR system in accordance with an embodiment.

FIG. 3 is a diagram of an illustrative silicon photomultiplier in accordance with an embodiment.

FIG. 4 is a diagram of illustrative optics and beam steering circuitry in a LIDAR system in accordance with an embodiment.

FIG. 5A is a side view of an illustrative tunable optical delay line having a cladding layer formed from electro-optical material in accordance with an embodiment.

FIG. 5B is a cross-sectional front view of an illustrative tunable optical delay line having a cladding layer formed from electro-optical material in accordance with an embodiment.

FIG. 5C is a top view of an illustrative tunable optical delay line having a cladding layer formed from electro-optical material in accordance with an embodiment.

FIG. 6A is a side view of an illustrative tunable optical delay line having multiple cladding layers formed from electro-optical material in accordance with an embodiment.

FIG. 6B is a cross-sectional front view of an illustrative tunable optical delay line having multiple cladding layers formed from electro-optical material in accordance with an embodiment.

FIG. 6C is a top view of an illustrative tunable optical delay line having multiple cladding layers formed from electro-optical material in accordance with an embodiment.

FIG. 7 is a side view of an illustrative tunable optical delay line having a strip-loaded core layer and a cladding layer formed from electro-optical material in accordance with an embodiment.

FIG. 8 is a side view of an illustrative tunable optical delay line having a rib-shaped core layer and multiple cladding layers formed from electro-optical material in accordance with an embodiment.

FIG. 9 is a side view of an illustrative tunable optical delay line having a diffused core layer in a cladding layer and another cladding layer formed from electro-optical material in accordance with an embodiment.

### DETAILED DESCRIPTION

Embodiments relate to LIDAR systems having tunable optical delay lines.

Some imaging systems include image sensors that sense light by converting impinging photons into electrons or holes that are integrated (collected) in pixel photodiodes within the sensor array. After completion of an integration cycle, collected charge is converted into a voltage, which is supplied to the output terminals of the sensor. In complementary metal-oxide semiconductor (CMOS) image sensors, the charge to voltage conversion is accomplished directly in the pixels themselves and the analog pixel voltage is transferred to the output terminals through various pixel addressing and scanning schemes. The analog pixel voltage can also be later converted on-chip to a digital equivalent and processed in various ways in the digital domain.

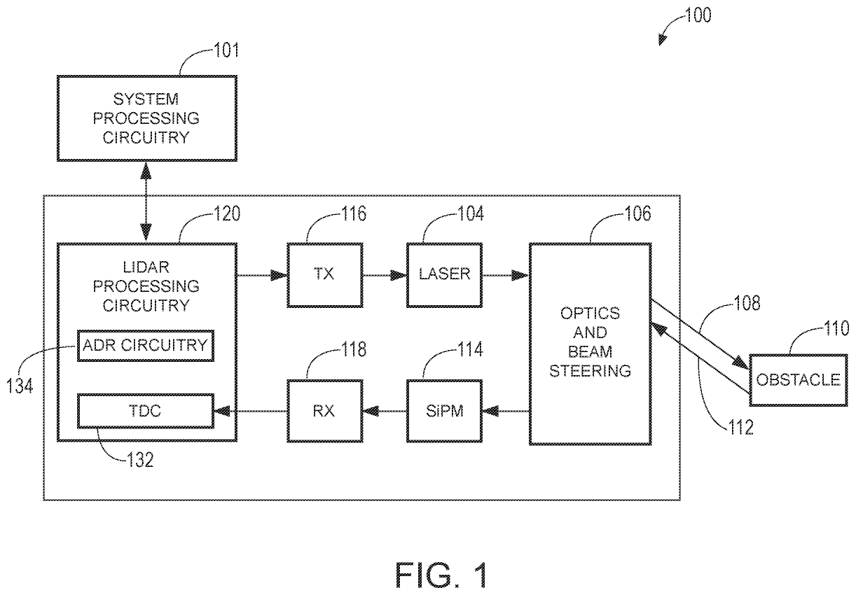

In light detection and ranging (LIDAR) devices (such as the ones described in connection with FIGS. 1-4), on the other hand, the photon detection principle is different. LIDAR devices may include a light source, such as a laser, that emits light toward a target object/scene. The light sensing diode in the LIDAR devices may be biased slightly above its breakdown point and when an incident photon from the laser (e.g., light that has reflected off the target object/scene) generates an electron or hole, this carrier initiates an avalanche breakdown with additional carriers being generated. The avalanche multiplication may produce a current signal that can be easily detected by readout circuitry associated with a single-photon avalanche diode (SPAD). The avalanche process needs to be stopped (quenched) by lowering the diode bias below its breakdown point.

LIDAR devices may utilize an optical phased array with a tunable optical delay line to allow for laser beam steering and scanning. This may allow for the angle at which the laser beam is output to be adjusted without movable parts. By changing an optical path length of the tunable optical delay line, the delay time may in turn be changed. The optical path length of a tunable optical delay line may be changed by heating thermal-optical materials within the delay line, thereby changing the refractive index of the material and altering the path length of the laser as it is output through the delay line. However, making these adjustments thermal-optically may be slow, as a lot of time may be required for the material to reach thermal equilibrium, may require high power consumption to generate the heat required, and may have a high packaging cost.

Instead of thermal-optical modulation, free-carrier changes have also been utilized in optical delay lines to adjust the index of refraction of materials within the lines. However, such free-carrier changes have a weak effect on the index of refraction and only allow a small area to pass light, resulting in an inefficient tunable delay line.

To yield quicker and more efficient changes in the index of refraction of delay line materials, electro-optical materials may be used. For example, a core layer of the delay line may include electro-optical material to allow for adjustments of the path length. However, adjusting an index of refraction of the core layer may result in high insertion losses between the waveguide (e.g., the core and cladding layers) because of refractive index mismatching that results in coupling losses, as well as high propagation losses within the delay line. Additionally, an electro-optical core layer may be difficult to incorporate within a delay line. Therefore, alternatively or additionally, it may be desirable to include electro-optical material in the cladding layers of the delay lines.

FIG. 1 is a schematic diagram of an illustrative system that includes a LIDAR imaging system. System 100 of FIG. 1 may be vehicle safety system (e.g., an active braking system or other vehicle safety system), a surveillance system, a medical imaging system, a general machine vision system, or any other desired type of system.

System 100 includes a LIDAR-based imaging system 102, sometimes referred to as a LIDAR module. LIDAR module 102 may be used to capture images of a scene and measure distances to obstacles (also referred to as targets) in the scene.

As an example, in a vehicle safety system, information from the LIDAR module may be used by the vehicle safety system to determine environmental conditions surrounding the vehicle. For example, vehicle safety systems may include systems such as a parking assistance system, an automatic or semi-automatic cruise control system, an auto-braking system, a collision avoidance system, a lane keeping system (sometimes referred to as a lane-drift avoidance system), a pedestrian detection system, etc. In at least some instances, a LIDAR module may form part of a semi-autonomous or autonomous self-driving vehicle.

LIDAR module may include a laser 104 that emits light 108 to illuminate an obstacle 110 (also referred to as a target, scene, or object herein). The laser may emit light 108 at any desired wavelength (e.g., infrared light, visible light, etc.). Optics and beam-steering equipment 106 may be used to direct the light beam from laser 104 towards obstacle 110 Light 108 may illuminate obstacle 110 and return to the LIDAR module as a reflection 112. One or more lenses in optics and beam-steering 106 may focus the reflected light 112 onto silicon photomultiplier (SiPM) 114 (sometimes referred to as SiPM sensor 114).

Silicon photomultiplier 114 is a single-photon avalanche diode (SPAD) device. In other words, silicon photomultiplier 114 may include a plurality of single-photon avalanche diodes. In single-photon avalanche diode (SPAD) devices, the light sensing diode is biased above its breakdown point. When an incident photon generates an electron or hole, this carrier initiates an avalanche breakdown with additional carriers being generated. The avalanche multiplication may produce a current signal that can be easily detected by readout circuitry associated with the SPAD. The avalanche process can be stopped (or quenched) by lowering the diode bias below its breakdown point. Each SPAD may therefore include a passive and/or active quenching circuit for halting the avalanche. The SPAD pixels may be used to measure photon time-of-flight (ToF) from a synchronized light source (e.g., laser 104) to a scene object point and back to the sensor, which can be used to obtain a 3-dimensional image of the scene.

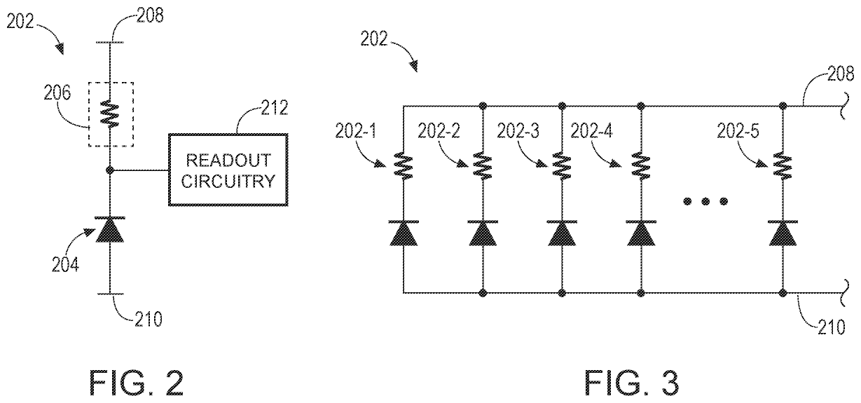

An example of a SPAD pixel is shown in FIG. 2. As shown in FIG. 2, SPAD device 202 includes a SPAD 204 that is coupled in series with quenching circuitry 206 between a first supply voltage terminal 208 (e.g., a ground power supply voltage terminal) and a second supply voltage terminal 210 (e.g., a positive power supply voltage terminal). During operation of SPAD device 202, supply voltage terminals 208 and 210 may be used to bias SPAD 204 to a voltage that is higher than the breakdown voltage. Breakdown voltage is the largest reverse voltage that can be applied without causing an exponential increase in the leakage current in the diode. When SPAD 204 is biased above the breakdown voltage in this manner, absorption of a single-photon can trigger a short-duration but relatively large avalanche current through impact ionization.

Quenching circuitry 206 (sometimes referred to as quenching element 206) may be used to lower the bias voltage of SPAD 204 below the level of the breakdown voltage. Lowering the bias voltage of SPAD 204 below the breakdown voltage stops the avalanche process and corresponding avalanche current. There are numerous ways to form quenching circuitry 206. Quenching circuitry 206 may be passive quenching circuitry or active quenching circuitry. Passive quenching circuitry may automatically quench the avalanche current without external control or monitoring once initiated. For example, FIG. 2 shows an example where a resistor is used to form quenching circuitry 206. This is an example of passive quenching circuitry. After the avalanche is initiated, the resulting current rapidly discharges the capacity of the device, lowering the voltage at the SPAD to near to the breakdown voltage. The resistance associated with the resistor in quenching circuitry 206 may result in the final current being lower than required to sustain itself. The SPAD may then be reset to above the breakdown voltage to enable detection of another photon.

This example of passive quenching circuitry is merely illustrative. Active quenching circuitry may also be used in SPAD device 202. Active quenching circuitry may reduce the time it takes for SPAD device 202 to be reset. This may allow SPAD device 202 to detect incident light at a faster rate than when passive quenching circuitry is used, improving the dynamic range of the SPAD device. Active quenching circuitry may modulate the SPAD quench resistance. For example, before a photon is detected, quench resistance is set high and then once a photon is detected and the avalanche is quenched, quench resistance is minimized to reduce recovery time.

SPAD device 202 may also include readout circuitry 212. There are numerous ways to form readout circuitry 212 to obtain information from SPAD device 202. Readout circuitry 212 may include a pulse counting circuit that counts arriving photons. Alternatively or additionally, readout circuitry 212 may include time-of-flight circuitry that is used to measure photon time-of-flight (ToF). The photon time-of-flight information may be used to perform depth sensing.

In one example, photons may be counted by an analog counter to form the light intensity signal as a corresponding pixel voltage. The ToF signal may be obtained by also converting the time of photon flight to a voltage. The example of an analog pulse counting circuit being included in readout circuitry 212 is merely illustrative. If desired, readout circuitry 212 may include digital pulse counting circuits. Readout circuitry 212 may also include amplification circuitry if desired.

The example in FIG. 2 of readout circuitry 212 being coupled to a node between diode 204 and quenching circuitry 206 is merely illustrative. Readout circuitry 212 may be coupled to any desired portion of the SPAD device. In some cases, quenching circuitry 206 may be considered integral with readout circuitry 212.

Because SPAD devices can detect a single incident photon, the SPAD devices are effective at imaging scenes with low light levels. Each SPAD may detect how many photons are received within a given period of time (e.g., using readout circuitry that includes a counting circuit). However, as discussed above, each time a photon is received and an avalanche current initiated, the SPAD device must be quenched and reset before being ready to detect another photon. As incident light levels increase, the reset time becomes limiting to the dynamic range of the SPAD device (e.g., once incident light levels exceed a given level, the SPAD device is triggered immediately upon being reset). Moreover, the SPAD devices may be used in a LIDAR system to determine when light has returned after being reflected from an external object.

Multiple SPAD devices may be grouped together to help increase dynamic range. The group or array of SPAD devices may be referred to as a silicon photomultiplier (SiPM). Two SPAD devices, more than two SPAD devices, more than ten SPAD devices, more than one hundred SPAD devices, more than one thousand SPAD devices, etc. may be included in a given silicon photomultiplier. An example of multiple SPAD devices grouped together is shown in FIG. 3.

FIG. 3 is a circuit diagram of an illustrative group 220 of SPAD devices 202. The group of SPAD devices may be referred to as a silicon photomultiplier (SiPM). As shown in FIG. 3 silicon photomultiplier 220 may include multiple SPAD devices that are coupled in parallel between first supply voltage terminal 208 and second supply voltage terminal 210. FIG. 3 shows N SPAD devices 202 coupled in parallel (e.g., SPAD device 202-1, SPAD device 202-2, SPAD device 202-3, SPAD device 202-4 . . . SPAD device 202-N). More than two SPAD devices, more than ten SPAD devices, more than one hundred SPAD devices, more than one thousand SPAD devices, etc. may be included in a given silicon photomultiplier.

Herein, each SPAD device may be referred to as a SPAD pixel 202. Although not shown explicitly in FIG. 3, readout circuitry for the silicon photomultiplier may measure the combined output current from all of SPAD pixels in the silicon photomultiplier. In this way, the dynamic range of an imaging system including the SPAD pixels may be increased. However, if desired, each SPAD pixel may have individual readout circuitry. Each SPAD pixel is not guaranteed to have an avalanche current triggered when an incident photon is received. The SPAD pixels may have an associated probability of an avalanche current being triggered when an incident photon is received. There is a first probability of an electron being created when a photon reaches the diode and then a second probability of the electron triggering an avalanche current. The total probability of a photon triggering an avalanche current may be referred to as the SPAD's photon-detection efficiency (PDE). Grouping multiple SPAD pixels together in the silicon photomultiplier therefore allows for a more accurate measurement of the incoming incident light. For example, if a single SPAD pixel has a PDE of 50% and receives one photon during a time period, there is a 50% chance the photon will not be detected. With the silicon photomultiplier 220 of FIG. 3, chances are that two of the four SPAD pixels will detect the photon, thus improving the provided image data for the time period and allowing for a more accurate measurement of the incoming light.

The example of a plurality of SPAD pixels having a common output in a silicon photomultiplier is merely illustrative. In the case of an imaging system including a silicon photomultiplier having a common output for all of the SPAD pixels, the imaging system may not have any resolution in imaging a scene (e.g., the silicon photomultiplier can just detect photon flux at a single point). It may be desirable to use SPAD pixels to obtain image data across an array to allow a higher resolution reproduction of the imaged scene. In cases such as these, SPAD pixels in a single imaging system may have per-pixel readout capabilities. Alternatively, an array of silicon photomultipliers (each including more than one SPAD pixel) may be included in the imaging system. The outputs from each pixel or from each silicon photomultiplier may be used to generate image data for an imaged scene. The array may be capable of independent detection (whether using a single SPAD pixel or a plurality of SPAD pixels in a silicon photomultiplier) in a line array (e.g., an array having a single row and multiple columns or a single column and multiple rows) or an array having more than ten, more than one hundred, or more than one thousand rows and/or columns.

Returning to FIG. 1, LIDAR module 102 may also include a transmitter 116 and receiver 118. LIDAR processing circuitry 120 may control transmitter 116 and laser 104. The LIDAR processing circuitry 120 may also receive data from receiver 118 (and SiPM 114). Based on the data from SiPM 114, LIDAR processing circuitry 120 may determine a distance to the obstacle 110. The LIDAR processing circuitry 120 may communicate with system processing circuitry 101. System processing circuitry 101 may take corresponding action (e.g., on a system-level) based on the information from LIDAR module 102.

LIDAR processing circuitry 120 may include time-to-digital converter (TDC) circuitry 132 and autonomous dynamic resolution (ADR) circuitry 134. The time-to-digital converter circuitry 132 may use time values (e.g., between the laser emitting light and the reflection being received by SiPM 114) to obtain a digital value representative of the distance to the obstacle 110.

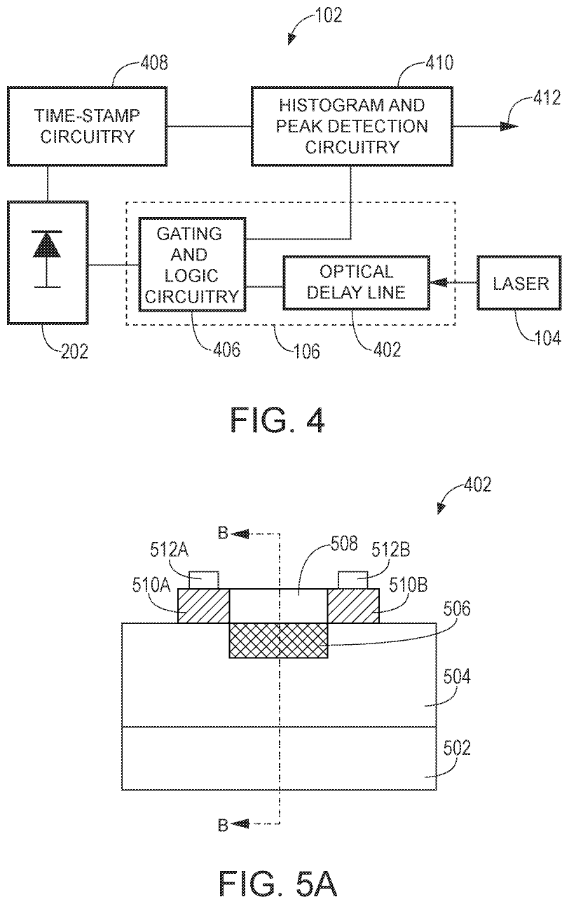

An illustrative diagram of LIDAR module 102 is shown in FIG. 4. As shown in FIG. 4, laser 104 may be directed through optical delay line 402. Optical delay line 402 may be adjusted by gating and logic circuitry 406 (gating and logic circuitry 406 may function as control circuitry for the optical delay line). In particular, optical delay line 402 may include electro-optical material, and gating and logic circuitry 406 may apply a voltage to the electro-optical material to change an index of refraction of the material, thereby changing an optical path length of optical delay line 402. The change in the optical path length of optical delay line 402 may change the delay time of the laser passing through optical delay line 402.

Gating and logic circuitry 406 may control the delay time of delay line 406. After laser 104 is emitted, SPAD pixel 202 may detect the reflection of laser 104 off external objects, such as obstacle 110 in FIG. 1. Time-stamp circuitry 408 may determine when the reflected laser light is detected as compared with the emission time of laser 104, which in turn is related to the delay time of optical delay line 402. Histogram and peak detection circuitry 410 may then compile all of the data and determine the peak time at which the reflected laser light was received (e.g., accounting for different reception times from different SPAD pixels 202 in SiPM 114). Histogram and peak detection circuitry 410 may then output a time-of-flight that corresponds to the peak time at which the reflected laser light was received along output 412.

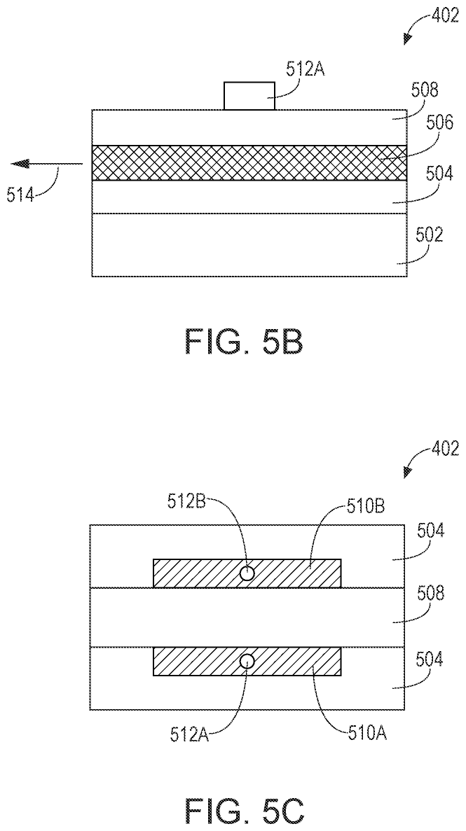

An example of a tunable optical delay line that may be used in LIDAR module 102 is shown in FIG. 5A. As shown in FIG. 5A, tunable optical delay line 402 may include a waveguide that includes substrate 502, first cladding 504, core 506, and second cladding 508. FIG. 5A may be a buried waveguide, in which core 506 is a separate layer from first cladding 504 and formed in a recess of first cladding 504. When light from laser 104 is emitted, it may propagate within core 506 due to total internal reflection. In other words, cladding layers 504 and 508 may have an index of refraction that ensures that the light is reflected back into core 506 as the light propagates along the length of core 506. For example, cladding layers 504 and 508 may have indices of refraction of 1.5, 1.45, between 1.4 and 1.5, or between 1.5 and 1.6, as examples. Core 506 may have an index of refraction greater than cladding layers 504 and 508. For example, core 506 may have an index of refraction of greater than 1.5, 1.5, between 1.5 and 1.6, or above 1.6, as examples. In this way, light in delay line 402 may be totally internally reflected by core 506 and the surrounding cladding layers 504 and 508.

By changing the index of refraction of one or both cladding layers, the path length of the light may be changed. Specifically, changing the index may change how far light extends into the cladding layer prior to being reflected back into core 506, thereby changing the amount of distance the light travels in the delay line and the amount of delay time. To perform these index of refraction changes, one or both of cladding 504 and 508 may be formed from electro-optical material. Electrodes 510A and 510B may apply a voltage to cladding 504 and/or cladding 508 when the electrodes are activated by contacts 512A and 512B (which in turn are connected to a voltage source). Electrodes 510A and 510B may be formed from indium tin oxide (ITO), another transparent conductor, or any other desired conductor. The applied voltage may change the index of refraction of the electro-optical material in cladding 504 and/or 508, thereby changing the optical path length in delay line 402 and changing the delay time.

Cladding 504 and/or cladding 508 may be formed from lanthanum-modified lead zirconate tantalite (PLZT), lithium niobate (LiNbO3), lithium triborate (LiB3O5), lithium tantalate (LiTaO3), potassium titanyl phosphate (KTiOPO4, or KTP), β-barium borate (β-BaB2O4, or BBO), liquid crystal, or any other desired electro-optical material. Cladding 504 and/or cladding 508 may be formed entirely of one or more of these electro-optical materials, or may be formed partially from one or more of these electro-optical materials. In general, the electro-optical material used for cladding 504 and cladding 508 may have an index of refraction of 1.5, 1.45, between 1.4 and 1.5, between 1.5 and 1.6, or other desired index. The electro-optical material may also have an extinction coefficient of less than 0.1, less than 0.2, less than 0.5, for example. In this way, the index of refraction and the extinction coefficient of cladding 504 and cladding 508 may meet the conditions necessary to propagate the light from laser 104 in delay line 402, and voltage may be applied to cladding 504 and/or cladding 508 to adjust the index of refraction of cladding 504 and/or cladding 508, thereby changing the delay time of delay line 402.

Although two electrodes 910A and 910B are shown in FIG. 5A, this is merely illustrative. A single electrode or more than two electrodes may be in contact with cladding 508, if desired.

A cross-sectional front view of delay line 402 is shown in FIG. 5B. As shown in FIG. 5B, cladding 504, core 506, and cladding 508 may be formed on substrate 502. When laser 402 is used, light may propagate within core 506 in direction 514. Cladding layers 504 and 508 may reflect the light back into core 506 so that light may propagate due to total internal reflection. Contact 512A may apply voltage to an electrode (such as electrode 510A—hidden in this cross-sectional view) to change the index of refraction of cladding layer 504 and/or cladding layer 508. The thickness of core 506 may be greater than the thicknesses of cladding layers 504 and 508. For example, core 506 may be more than 1.25 times thicker, more than 1.5 times thicker, or less than 2 times thicker than at least one of cladding layers 504 and 508. However, these relative thicknesses are merely illustrative. In general, core 506 may have any desired thickness relative to cladding layers 504 and 508 so that light propagates within core 506. Moreover, core 506 may have an index of refraction greater than cladding layers 504 and 508. For example, core 506 may have an index of refraction of greater than 1.5, 1.5, between 1.5 and 1.6, or above 1.6, as examples. In this way, light in delay line 402 may be totally internally reflected by core 506 and the surrounding cladding layers 504 and 508.

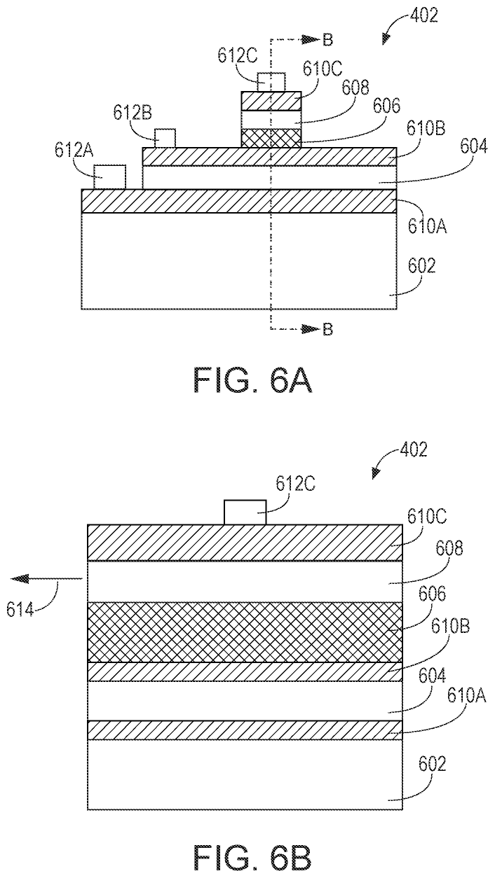

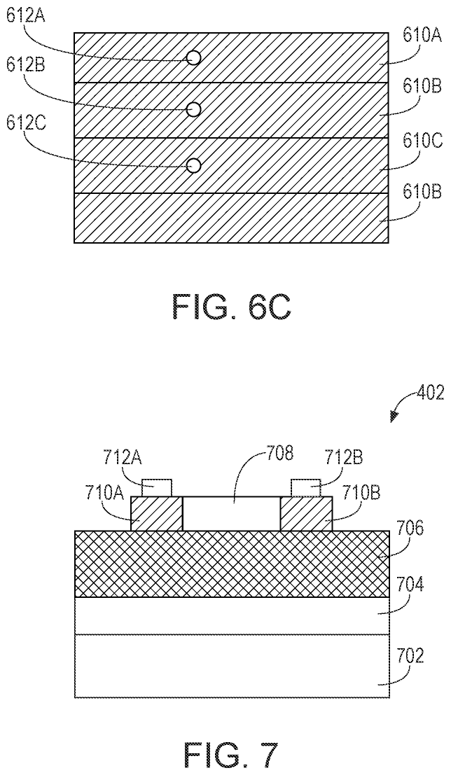

A top view of delay line 402 is shown in FIG. 5C. As shown in FIG. 5C, electrodes 510A and 510B may transfer voltage from contacts 512A and 512B to the sides of cladding 508 and/or the top of cladding 504, which may change the index of refraction of cladding 508 and/or cladding 504. Although FIGS. 5A-C have shown delay line 402 having a single layer of electrodes that may apply voltage to the top of cladding 504, this is merely illustrative. An example of delay line 402 having electrodes on both sides of a cladding layer is shown in FIGS. 6A-C.

As shown in FIG. 6A, electrode 610A may be interposed between substrate 602 and first cladding layer 604. Electrode 610B may be formed on cladding 604, followed by core 606, second cladding layer 608, and electrode 610C. Both cladding 604 and cladding 608 may be formed, either entirely or partially, from electro-optical material, such as lanthanum-modified lead zirconate tantalite (PLZT), lithium niobate (LiNbO3), lithium triborate (LiB3O5), lithium tantalate (LiTaO3), potassium titanyl phosphate (KTiOPO4, or KTP), β-barium borate (β-BaB2O4, or BBO), liquid crystal, or any other desired electro-optical material. Electrodes 610A, 610B, and 610C may transfer voltage from contacts 612A, 612B, and 612C to cladding layers 604 and 608 to change the indices of refraction of the cladding layers. Electrodes 610A, 610B, and 610C may be formed from indium tin oxide (ITO), another transparent conductor, or any other desired conductor. As previously described, changing the indices of refraction of cladding layers 604 and 608 layers may change the path length of the light in delay line 402, thereby changing the delay time.

Having both cladding layers 604 and 608 include electro-optical material may allow for greater control over the delay time. In particular, the indices of refraction of both layers may be changed in coordination, allowing for greater control of the propagation of light through delay line 402. Moreover, having electrodes 610A and 610B on both sides of cladding 604 may allow for faster changes to the index of refraction of cladding 604, as more voltage is applied and the layer may equilibrate more quickly. In general, each layer shown in FIG. 6A may be formed and be used similarly to the analogous layers of FIGS. 5A-C. For example, cladding layers 604 and 608 may have indices of refraction of 1.5, 1.45, between 1.4 and 1.5, or between 1.5 and 1.6, as examples. Core 606 may have an index of refraction greater than cladding layers 604 and 608. For example, core 606 may have an index of refraction of greater than 1.5, 1.5, between 1.5 and 1.6, or above 1.6, as examples. In this way, light in delay line 402 may be totally internally reflected by core 606 and the surrounding cladding layers 604 and 608.

A cross-sectional front view of delay line 402 is shown in FIG. 6B. As shown in FIG. 6B, electrodes 610A and 610B may extend along the length of cladding 604, and electrode 610C may extend along the length of cladding 608. Light may propagate within core 606 in direction 614. The thickness of core 606 may be greater than the thicknesses of cladding layers 604 and 608. For example, core 606 may be more than 1.25 times thicker, more than 1.5 times thicker, or less than 2 times thicker than at least one of cladding layers 604 and 608. However, these relative thicknesses are merely illustrative. In general, core 606 may have any desired thickness relative to cladding layers 604 and 608 so that light propagates within core 606.

A top view of delay line 402 is shown in FIG. 6C. As shown in FIG. 6C, electrodes 610A, 610B, and 610C may transfer voltage from contacts 612A, 612B, and 612C to the underlying cladding layers 604 and 608 (as shown in FIG. 6A—hidden in the top view of FIG. 6C).

In general, the core, cladding, and electrode layers described in FIGS. 5 and 6 may be arranged in any desired manner. For example, in FIG. 7, delay line 402 may have a strip-loaded configuration, which is similar to the configuration shown in FIG. 5A, except that core 706 may extend completely across cladding 704. FIG. 7 is a side-view of delay line 402, so light may propagate into the page. Electrodes 710A and 710B may apply voltage to cladding 708, thereby changing the index of refraction of cladding 708, the optical distance of delay line 402, and the delay time. Substrate 702, cladding 704, core 706, cladding 708, electrodes 710A and 710B, and contacts 712A and 712B may otherwise be formed in the same manner and function as described above in connection with substrate 502, cladding 504, core 506, cladding 508, electrodes 510A and 510B, and contacts 512A and 512B of FIG. 5A, respectively.

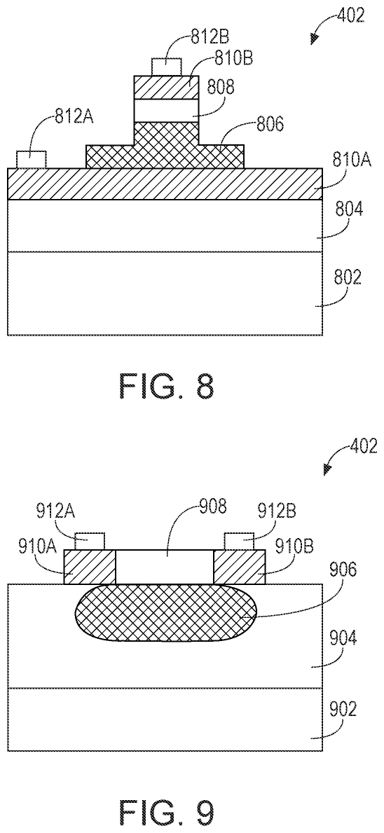

Another configuration for delay line 402 is shown in FIG. 8. As shown in FIG. 8, delay line 402 may have core 806 in a rib-shape configuration, and may have electrode 810A in contact with cladding 804 and electrode 810B in contact with cladding 808. In this way, electrodes 810A and 810B may receive voltage from contacts 812A and 812B and pass the voltage to cladding 804 and cladding 808, respectively. The voltage may change the indices of refraction of cladding 804 and cladding 808, thereby changing the optical path length in delay line 402 and the delay time. Substrate 802, cladding 804, core 806, cladding 808, electrodes 810A and 810B, and contacts 812A and 812B may otherwise be formed in the same manner and function as described above in connection with substrate 602, cladding 604, core 606, cladding 608, electrodes 610B and 610C, and contacts 612B and 612C of FIG. 6, respectively.

Another configuration for delay line 402 is shown in FIG. 9. As shown in FIG. 9, delay line 402 may have the same arrangement as described in connection with FIG. 5A, except that core 906 may be diffused within an upper portion of cladding 904 rather than being a completely separate layer. Otherwise, substrate 902, cladding 904, core 906, cladding 908, electrodes 910A and 910B, and contacts 912A and 912B may be formed in the same manner and function as described above in connection with substrate 502, cladding 504, core 506, cladding 508, electrodes 510A and 510B, and contacts 512A and 512B of FIG. 5A, respectively.

Although FIGS. 5-9 show various arrangements/configurations of delay line 402, these are merely illustrative. In general, any combination of cladding layers with electro-optical material, core, and electrode layers may be used to form a tunable optical delay line for a LIDAR system.

In any of the aforementioned embodiments, it should be understood that a silicon photomultiplier (with multiple SPAD pixels having a common output) may be used in place of a single SPAD pixel.

In various embodiments, an optical delay line for a light detection and ranging device may include a waveguide with a first cladding layer, a second cladding layer that includes electro-optical material, and a core interposed between the first cladding layer and the second cladding layer. The optical delay line may also include an electrode in contact with the second cladding layer.

In accordance with an embodiment, the electrode may apply a voltage to the second cladding layer to change an index of refraction of the second cladding layer.

In accordance with an embodiment, the electrode is a first electrode, and the optical delay line may further include a first contact from which the first electrode receives the voltage, a second electrode that is configured to apply the voltage to the second cladding layer, and a second contact from which the second electrode receives the voltage.

In accordance with an embodiment, the core may have an index of refraction of 1.5.

In accordance with an embodiment, the core may be a separate layer formed in a recess of first cladding.

In accordance with an embodiment, the core may be diffused in a portion of the first cladding.

In accordance with an embodiment, the first cladding layer may include electro-optical material.

In accordance with an embodiment, the electrode is a first electrode, and the optical delay line may further include a second electrode that applies voltage to the first cladding layer.

In accordance with an embodiment, the second electrode may be interposed between the core and the first cladding.

In accordance with an embodiment, the optical delay line may further include a third electrode that is interposed between a substrate and the first cladding.

In accordance with an embodiment, the first, second, and third electrodes may be formed from a transparent conductive material.

In accordance with an embodiment, the first, second, and third electrodes may be formed from indium tin oxide.

In accordance with an embodiment, the core may have a rib-shape, and the first electrode may be formed directly on the substrate.

In accordance with an embodiment, the electro-optical material may be selected from the group of materials consisting of: lanthanum-modified lead zirconate tantalite (PLZT), lithium niobate (LiNbO3), lithium triborate (LiB3O5), lithium tantalate (LiTaO3), potassium titanyl phosphate (KTiOPO4), β-barium borate (β-BaB2O4), and liquid crystal.

In accordance with various embodiments, a light detection and ranging device may include a laser, a tunable optical delay line through which the laser outputs laser light, wherein the laser light propagates in a waveguide in the optical delay line. The waveguide may include a first cladding layer, a second cladding layer that includes electro-optical material, and a core interposed between the first cladding layer and the second cladding layer. The light detection and ranging device may further include control circuitry that adjusts a delay time of the tunable optical delay line, a single photon avalanche diode that is configured to detect laser light that has been reflected off of external objects, and peak detection circuitry that determines a time-of-flight based on the delay time and the detection of the reflected laser light.

In some embodiments, the control circuitry may be configured to adjust the delay time of the optical delay line by applying a voltage to the electro-optical material that forms the second cladding layer.

In some embodiments, the electro-optical material may be selected from the group of materials consisting of: lanthanum-modified lead zirconate tantalite (PLZT), lithium niobate (LiNbO3), lithium triborate (LiB3O5), lithium tantalate (LiTaO3), potassium titanyl phosphate (KTiOPO4), β-barium borate (β-BaB2O4), and liquid crystal.

In some embodiments, the first cladding layer may have a first index of refraction, the second cladding layer may have a second index of refraction, and the core may have a third index of refraction that is less than the first and second indexes of refraction.

In various embodiments, a tunable optical delay line for a light detection and ranging device may include a substrate, a first cladding layer on the substrate, a second cladding layer that includes electro-optical material, a core interposed between the first cladding layer and the second cladding layer, an electrode in contact with the second cladding layer, and a contact that receives voltage and transfers the voltage to the electrode, wherein the voltage is configured to change an index of refraction of the second cladding layer.

In accordance with some embodiments, the electrode is a first electrode and the first cladding layer comprises electro-optical material. The tunable optical delay line may further include a second electrode in contact with the first cladding layer. The second electrode may receive the voltage to change an index of refraction of the first cladding layer.

The foregoing is merely illustrative of the principles and various modifications can be made by those skilled in the art. The foregoing embodiments may be implemented individually or in any combination.

What is claimed is:

1. An optical delay line for a light detection and ranging device comprising:
a waveguide comprising:
a first cladding layer,
a second cladding layer that includes electro-optical material, and
a core interposed between the first cladding layer and the second cladding layer; and
an electrode in contact with the second cladding layer.

2. The optical delay line defined in claim 1 wherein the electrode is configured to apply a voltage to the second cladding layer to change an index of refraction of the second cladding layer.

3. The optical delay line defined in claim 2 wherein the electrode is a first electrode, the optical delay line further comprising:
a first contact from which the first electrode receives the voltage;
a second electrode that is configured to apply the voltage to the second cladding layer; and
a second contact from which the second electrode receives the voltage.

4. The optical delay line defined in claim 3 wherein the core has an index of refraction of 1.5.

5. The optical delay line defined in claim 3 wherein the core is a separate layer formed in a recess of first cladding.

6. The optical delay line defined in claim 3 wherein the core is diffused in a portion of the first cladding.

7. The optical delay line defined in claim 2 wherein the first cladding layer includes electro-optical material.

8. The optical delay line defined in claim 7 wherein the electrode is a first electrode and the voltage is a first voltage, the optical delay line further comprising:
a second electrode that applies a second voltage to the first cladding layer.

9. The optical delay line defined in claim 8 wherein the second electrode is interposed between the core and the first cladding.

10. The optical delay line defined in claim 9 further comprising:
a third electrode that is interposed between a substrate and the first cladding.

11. The optical delay line defined in claim 10 wherein the first, second, and third electrodes are formed from a transparent conductive material.

12. The optical delay line defined in claim 11 wherein the first, second, and third electrodes are formed from indium tin oxide.

13. The optical delay line defined in claim 9 wherein the core has a rib-shape, and the first electrode is formed directly on the substrate.

14. The optical delay line defined in claim 2 wherein the electro-optical material is selected from the group of materials consisting of: lanthanum-modified lead zirconate tantalite (PLZT), lithium niobate (LiNbO3), lithium triborate (LiB3O5), lithium tantalate (LiTaO3), potassium titanyl phosphate (KTiOPO4), β-barium borate (β-BaB2O4), and liquid crystal.

15. A light detection and ranging device comprising:
a laser;
a tunable optical delay line through which the laser outputs laser light, wherein the laser light propagates in a waveguide in the optical delay line and wherein the waveguide comprises:
a first cladding layer,
a second cladding layer that includes electro-optical material, and
a core interposed between the first cladding layer and the second cladding layer;
control circuitry that adjusts a delay time of the tunable optical delay line;
a single photon avalanche diode that is configured to detect laser light that has been reflected off of external objects; and
peak detection circuitry that determines a time-of-flight based on the delay time and the detection of the reflected laser light.

16. The light detection and ranging device defined in claim 15 wherein the control circuitry is configured to adjust the delay time of the optical delay line by applying a voltage to the electro-optical material that forms the second cladding layer.

17. The light detection and ranging device defined in claim 16 wherein the electro-optical material is selected from the group of materials consisting of: lanthanum-modified lead zirconate tantalite (PLZT), lithium niobate (LiNbO3), lithium triborate (LiB3O5), lithium tantalate (LiTaO3), potassium titanyl phosphate (KTiOPO4), β-barium borate (β-BaB2O4), and liquid crystal.

18. The light detection and ranging device defined in claim 15 wherein the first cladding layer has a first index of refraction, the second cladding layer has a second index of refraction, and the core has a third index of refraction that is less than the first and second indexes of refraction.

19. A tunable optical delay line for a light detection and ranging device comprising:
a substrate;
a first cladding layer on the substrate;
a second cladding layer that includes electro-optical material;
a core interposed between the first cladding layer and the second cladding layer;
an electrode in contact with the second cladding layer; and
a contact that receives voltage and transfers the voltage to the electrode, wherein the voltage is configured to change an index of refraction of the second cladding layer.

20. The tunable optical delay line defined in claim 19 wherein the electrode is a first electrode and the first cladding layer comprises electro-optical material, the tunable optical delay line further comprising:
a second electrode in contact with the first cladding layer, wherein the second electrode receives the voltage to change an index of refraction of the first cladding layer.
